(19) United States
(12) Patent Application Publication
(10) Pub. No.: US 2011/0076107 A1
(43) Pub. Date: Mar. 31, 2011

(54) Tap with Dual Relief Technology

(75) Inventor: Young Bae Lee, Koyang City (KR)

(73) Assignee: YG-1 CO., LTD., Pupyoung-Gu (KR)

(21) Appl. No.: 12/567,444

(22) Filed: Sep. 25, 2009

(51) Int. Cl. B23D 77/00

(52) U.S. Cl. 408/222

(57) ABSTRACT

The present disclosure is directed to a dual technology relief tap, and more specifically, to a relief tap where a segment on the threaded portion has a first type of relief and the remainder of the threads have a second type of relief or a concentric thread to limit tilt and loosening and ultimately to prevent overfeed or underfeed. In some embodiments, a neutral, negative, positive, convex, or other type of relief is applied generally to most of the threaded portion with or without concentric threads, and a second type of relief of any type, such as a neutral, a negative, a positive, a convex, or other relief, is applied to some selected threads. In another embodiment, the second type of relief is applied to the first threads after the chamfer or are spaced regularly over the threaded surface.

### FIELD OF THE DISCLOSURE

The present disclosure is directed to a dual relief tap, and more specifically, to a relief tap where a segment on the threaded body, likely next to the chamfer of the tap, has a first relief technology, and at least a second segment of the threaded body has a second relief technology to limit overfeed and underfeed effects during tapping.

### BACKGROUND OF THE INVENTION

Threads are used to mate pieces and convert torque into axial force between two objects. The first object, such as a bolt anchored to a piece to be secured, has male threads on its outer surface and is screwed into a second object with mating female threads on the inner surface of an opening. The use of threads as a fastening means is well known. To form threads on the inner surface of the opening, a hole is drilled using a drill bit where female threads are created in a subsequent step. The drill bit, because of its rapid rotational speed, removes chips of matter but leaves the surface of the hole relatively flat. Threads must be added to the surface in a second step using a manual tap as shown in FIG. 1 or any other type of tap.

Taps are cutting tools used to create threads in solid substances, including but not limited to metal, wood, or plastic, by shaving away thread-like areas on the inner surface of a cylindrical hole. To ease threading forces on the tap, threads are cut during a process that includes screwing in the tap over a handful rotations to remove small layers as shown in the right end of FIG. 7. Male taps 100 in FIG. 1 (i.e., taps capable of forming female threads inside of holes) are generally sold in the form of a long cylindrical tool body tool with a threaded length and a shank equipped with an end portion for positioning the tap in a torque-creating support.

A user attaches the tap 100 inside a torque support 36, places the tap on the hole of a piece, and screws the tap 100 into the hole to create threads. The first rotations of the tap inside the hole are critical. Misalignment, uneven driving forces, or incorrect tap technology may result in the creation of undesired, uneven mating threads.

Taps often include fluted openings made longitudinally along the thread length. These flutes define land portions between two flutes where chips removed from the surface being threaded are evacuated upwards and out of the hole. FIG. 1 shows a tap 100 placed inside a torque-creating support 36 operated by a user 40 and stabilized in a grip 38. While a manual support 36 is shown, nonmanual supports are also used interchangeably with the disclosed technology.

Three types of fluted taps are shown in FIGS. 2-4, respectively. FIG. 2 is a spiral flute tap where the fluted openings spiral along the length of the threaded body creating lands between the fluted openings of fixed lengths but where the cutting edge at the intersection of each land with the flute is a cutting surface at an attack angle. FIG. 3 illustrates a straight flute tap where the fluted openings are longitudinally aligned with the tap axis. In this type of tap, each thread has a similar cutting edge on the edge of the opening and there is no forward cutting attack angle. FIG. 4 illustrates a gunpoint tap where, in the chamfer area of each land, the width of each thread decreases to create an intermediary configuration between the tap of FIG. 2 and the tap of FIG. 3. This type of tap benefits from a greater attack angle in the chamfer area for each thread edge and a linear threaded portion past the chamfer.

FIG. 5 is a close-up view of the cutting edge a variable angle at a cutting edge of a land of a spiral flute tap of FIG. 2, or a variable angle at a cutting edge of a land in the chamfer area of the gunpoint tap of FIG. 4. As shown, each thread has a leading flank and a trailing flank where both flanks attack at different angles a surface into which they cut. FIG. 6 shows the opposite configuration of the straight fluted tap of FIG. 3 or the threaded portion of the gunpoint tap of FIG. 4 where the cutting edge is aligned with the fluted openings, resulting in a symmetrical cutting angle.

When taps enter a drilled hole, the surface where material is intended to be cut is removed in incremental layers as the chamfered threads are rotated in. Without a chamfer, the first thread would need to remove the totality of the material to be cut, would require great torque to operate, and would be subject to dulling of the cutting edge. On the right of FIG. 7 is an animation view of the tip of a tap where a chamfer area enters a drilled hole over six consecutive rotations and creates perfect threads. On the left of FIG. 7, a normal tapping process creates a normal thread (i.e., a V-shaped thread in the metal). On the right, an overfed thread (i.e., a staircase-shaped thread in the metal) is created when overfeeding of the tap occurs. At each rotation, the tap advances a fraction of a thread forward and cuts into the thread in a step-forward manner. FIG. 8 is a close-up view of an overfed tooth where the overfeed is shown while each subsequent thread in the chamfer area is entered. The tap 100 is illustrated along with the cutting layers of the thread as shown in lines within the thread. FIG. 9 is the same close-up view but of an underfed tooth. Lines 150 show the shape of the teeth produced during the overfeed and underfeed.

Overfeeding can be caused by a plurality of effects. The main effect stems from the need to reduce frictional forces between the external surface of the threads on the tap as the tap enters the internal surface of the object being threaded. To reduce the friction, flutes are cut into the threads. Also, these flutes serve to evacuate from the chamfer chips of material cut from the surface. To further reduce friction, a portion of each thread in the back of the cutting edge is tapered away from the material surface in what is called a “relief.” A relieved thread is distanced at some point from the inner surface of the hole in which it burrows. The gap created between the thread and the object's inner surface, while beneficial to the tap, loosens the tap to some extent. A loosened tap may move, tilt, change position, and cause overfeed or underfeed.

To illustrate the relief, FIGS. 10-11, 13-16, and 18-24 use a segment made of a tap with several adjacent threads over a portion of a land between two adjacent flutes. The tap is shown as a solid. The gap created by the relief of each thread, i.e., the distance between the internal surface of the drilled hole and the external surface of the tap, is illustrated using lines over the solid to show the distance from a threaded object's inner surface as it would be if an x-ray were taken of the tap inside the hole. One of ordinary skill in this art will recognize on these figures how reliefs, thread designs, and chamber designs are made without undue experimentation.

FIG. 10 illustrates a regular eccentric relief 151 where the distance increases regularly from the front to the back of the land along each thread. Another possible form of relief is illustrated in FIG. 11 where some threads are removed altogether 152 from the threaded region on the tap. FIG. 12 shows how the top portion of each thread can be recessed 153 (i.e., a flattened thread) to reduce the contact area between the tap and the material in which the tap is inserted and provide additional relief. As shown in FIG. 12, threads distant from the chamfer are shown as recessed, but the use of recessed relief in any portion of the threaded area on a tap is contemplated. FIG. 13 shows a land concentric threads 154, FIG. 14 illustrates an eccentric 155 thread relief, FIG. 15 a con-eccentric thread relief 156, and FIG. 16 a specially shaped thread relief where portions of the middle thread are shifted away from the contact surface (not illustrated by dashed lined but simply on the solid thread). One of ordinary skill in the art of tap design will understand that while a handful of different types of relief are shown in FIGS. 10-16, other single relief types are also contemplated.

Different technologies of relief exist to help reduce frictional forces on the tap, and each technology results directly or indirectly in overfeed or underfeed of the tap. What is needed is a tap with a new type of relief designed to keep the structure of the tap centered and aligned and to prevent any overfeed or underfeed during the creation of threads by the tap.

### SUMMARY

The present disclosure is directed to a dual technology relief tap, and more specifically, to a relief tap where a segment on the threaded portion has a first type of relief and the remainder of the threads have a second type of relief or a concentric thread to limit tilt and loosening and ultimately to prevent overfeed or underfeed. In some embodiments, a neutral, negative, positive, convex, or other type of relief is applied generally to most of the threaded portion with or without concentric threads, and a second type of relief of any type, such as a neutral, a negative, a positive, a convex, or other relief, is applied to some selected threads. In another embodiment, the second type of relief is applied to the first threads after the chamfer or are spaced regularly over the threaded surface.

### BRIEF DESCRIPTION OF THE DRAWINGS

The features of the present disclosure are believed to be novel and are set forth with particularity in the appended claims. The disclosure may best be understood by reference to the following description taken in conjunction with the accompanying drawings, where the figures that employ like reference numerals identify like elements.

FIG. 1 is an illustration of a fluted tap with a torque-creating support in a piece secured to a vice grip.

FIG. 2 is a side view of a spiral fluted tap.

FIG. 3 is a side view of a straight fluted tap.

FIG. 4 is a side view of a gunpoint tap.

FIG. 5 is an illustration of the cutting edge on a curved land of a fluted tap.

FIG. 6 is an illustration of the cutting edge on a straight land of a fluted tap.

FIG. 7 is a dual animated view of the tapping process of a tap without overfeed and with overfeed.

FIG. 8 is a close-up view of an overfeed thread created in a material along with traces of the different cutting edges.

FIG. 9 is a close-up view of an underfeed thread created in a material along with traces of the different cutting edges.

FIG. 10 is an illustration of a regular thread relief on a fluted tap from the prior art.

FIG. 11 is an illustration of an interrupted thread relief on a fluted tap from the prior art.

FIG. 12 is an illustration of a spiral fluted tap, a straight fluted tap, and a gunpoint flute tap with recessed threads from the prior art.

FIG. 13 is an illustration of concentric threads on a fluted tap from the prior art.

FIG. 14 is an illustration of an eccentric thread relief on a fluted tap from the prior art.

FIG. 15 is an illustration of a con-eccentric thread relief on a fluted tap from the prior art.

FIG. 16 is an illustration of a specially shaped thread relief on a fluted tap from the prior art.

FIG. 17A is a side view used to illustrate schematically the nomenclature of tap cutting tools.

FIG. 17B is a detailed view of one of the lands located between two flutes of the tap cutting tool of FIG. 17A.

FIG. 17C is a top view of the tap cutting tool of FIG. 17A as seen from the cut line 17C-17C as shown in FIG. 17A.

FIG. 17D is a sectional view without shading of the tap cutting tool of FIG. 17A as seen from the cut line 17D-17D as shown in FIG. 17A.

FIG. 18 is a dual relief tap with an eccentric relief as a first type of relief and a convex relief as a second type of relief according to an embodiment of the present disclosure.

FIG. 19 is a dual relief tap with an eccentric relief as a first type of relief and concentric threads as a second type of threads according to another embodiment of the present disclosure.

FIG. 20 is a dual relief tap with an eccentric relief as a first type of relief and a negative relief as a second type of relief according to another embodiment of the present disclosure.

FIG. 21 is a dual relief tap with an eccentric relief as a first type of relief and a convex relief as a second type of relief according to another embodiment of the present disclosure.

FIG. 22 is a dual relief tap with an eccentric relief as a first type of relief and a combined negative and concentric relief set as a second type of relief or second type of threads according to another embodiment of the present disclosure.

FIG. 23 is a dual relief tap with an eccentric relief as a first type of relief and a combined eccentric, negative, and positive relief, and concentric threads at the second type of relief according to another embodiment of the present disclosure.

### DETAILED DESCRIPTION OF THE INVENTION

The present invention is not limited to the particular details of the device depicted and other modifications and applications may be contemplated. Further changes may be made in the above-described device without departing from the true spirit of the scope of the invention herein involved. It is intended, therefore, that the subject matter in the above depiction should be interpreted as illustrative, not in a limiting sense.

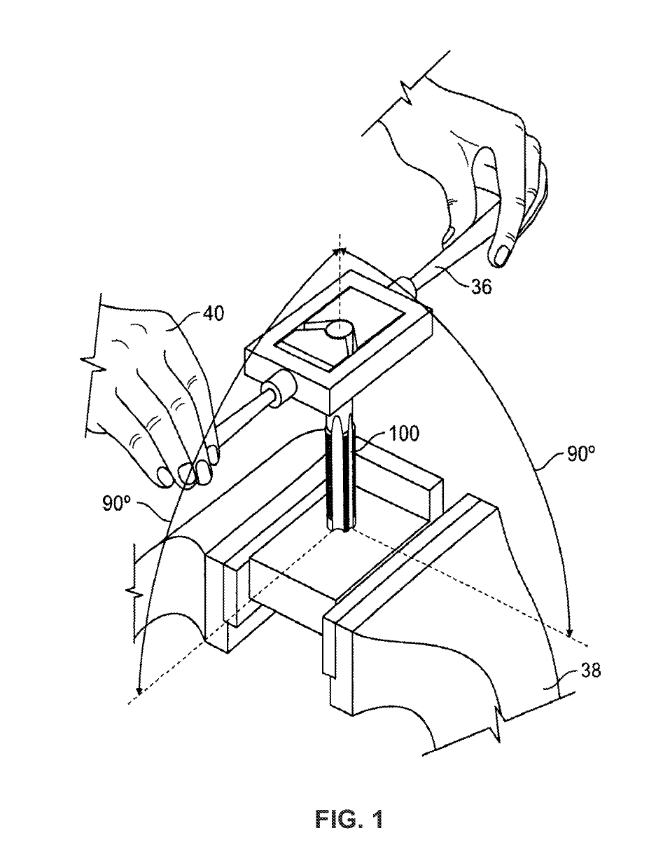

FIG. 1 illustrates how a tap 100 is operated by a user 40 to cut threads into a hole made in a block of material. The block is held in a vice grip 38 vertically using a torque-creating support 36, such as a small block with lateral support, movable by rotating two horizontal handles placed on each side of the torque-creating support 36. A user 40 then applies torque by rotating the handles in the horizontal plane. While a manual torque-creating support 36 is shown, what is contemplated within this disclosure is the use of any type of tap 100, using any engaging mechanism to rotate the tap, thus activating the cutting edges.

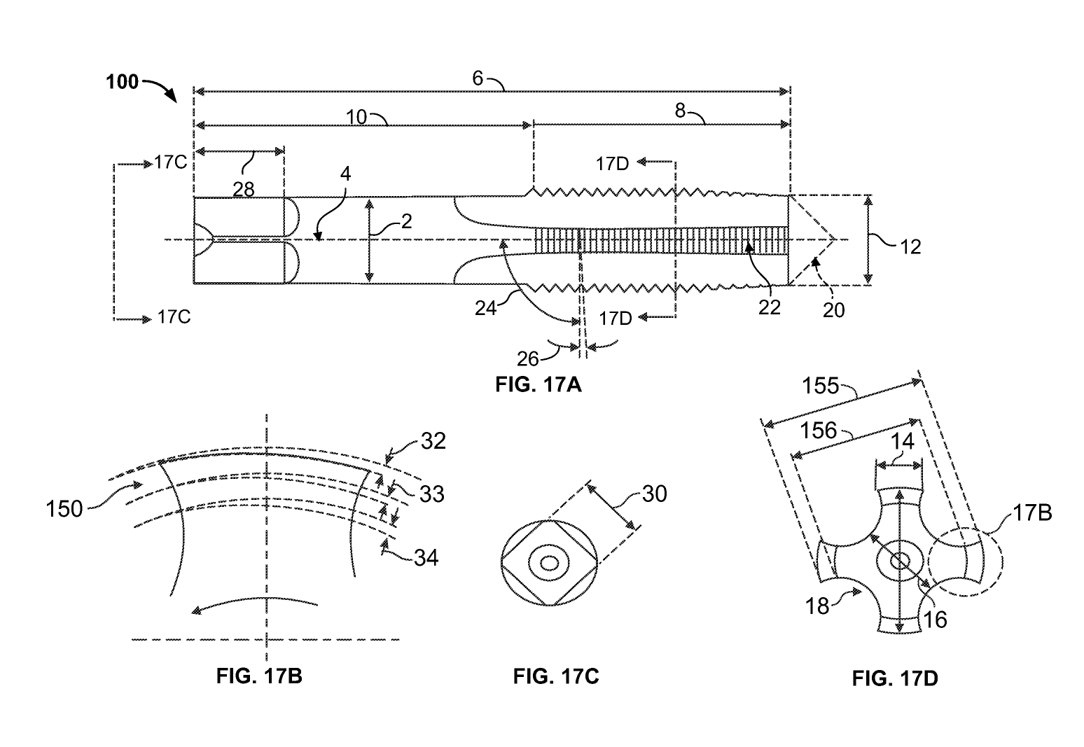

Describing a tap in general, FIG. 17A illustrates a tap 100 with an overall length 6 that may be separated into a thread length 8 and a shank length 10 having a fixed shank diameter 2. The ratio of these two lengths is purely illustrative, and it is understood that these lengths may vary according to the model and type of tap 100. The shank length 10 can also include a driving length 28 where the tap 100 is secured to a torque-creating support. The driving length 28 is also of a geometry as shown in FIG. 17C to allow for the coupling of the tap 100 to any needed torque-creating support. While a square attachment 30 is shown, any attachment is contemplated.

Flutes 18 as shown in FIG. 17D separate lands 22 created in the threaded length 8 between two consecutive flutes 18. In one embodiment as shown in FIG. 17D, four flutes 18 are positioned at 90 degrees circumferentially around the thread length 8. Other taps may have flutes 18 of smaller radii and variable curvature as shown in FIG. 3 and may be placed around a cylindrical tool body or minor diameter 12 of different sizes to create a tap 100 with five or more flutes 18 or three or fewer flutes 18. Also shown in FIG. 17A is a tap 100 with straight flutes 18. The use of a helical angle, a spiral, or any other type of flute 18 that is not aligned with the longitudinal axis 4 of the tap 100 is also contemplated.

Returning to FIG. 17A, the threaded length 8 comprises a series of V-shaped threads, each thread having a thread lead angle 26 corresponding to a pitch or average median thread distance between two consecutive threads. In some embodiments, as shown by dashed lines, the tap 100 includes a point 20. FIG. 17D is a sectional view without shading of the tap cutting tool of FIG. 17A as seen from cut line 17D-17D as shown in FIG. 17A. This section shows the land width 14 and a section with threads having a minor diameter 156 and a major diameter 155. FIGS. 17A-17D show that the cylindrical tool body of the tap 100 includes a longitudinal axis 4 rotatable about the longitudinal axis 4 and having successively a shank of shank length 10 and a threaded length 8 with at least a flute 18 for creating at least a land 22 with a front cutting surface 150 with a cutting edge and a heel as shown in FIG. 17B.

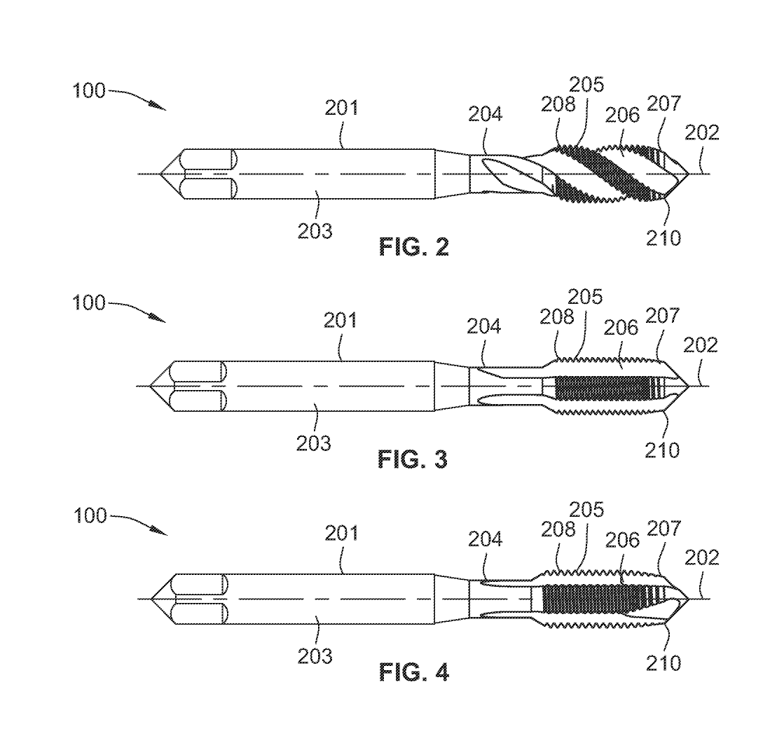

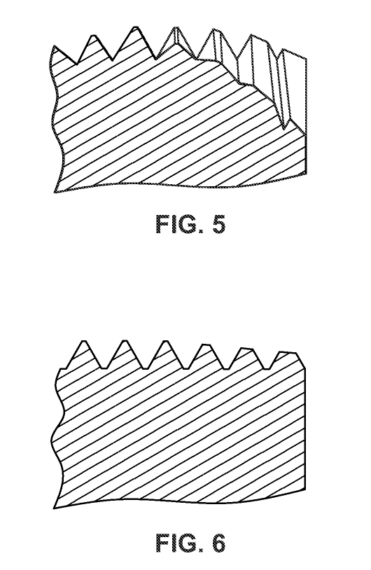

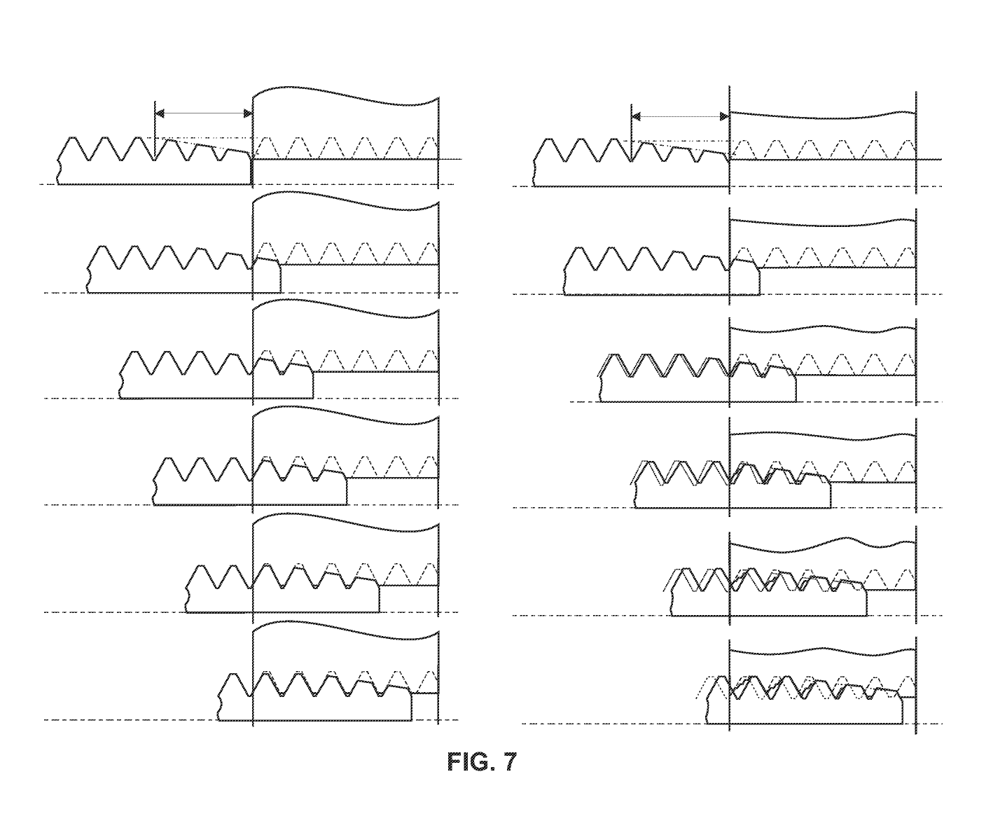

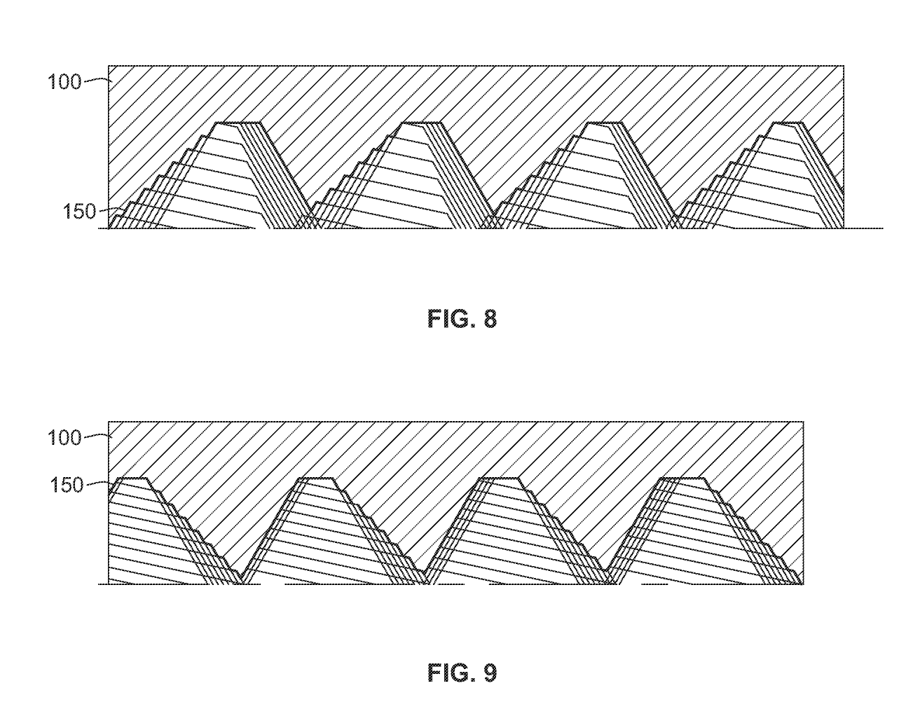

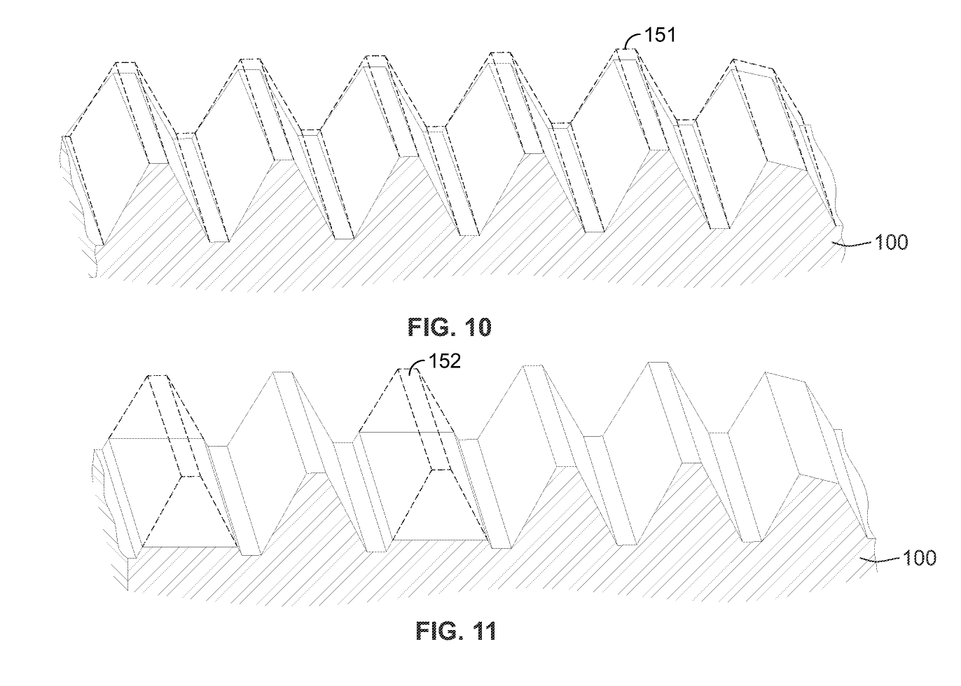

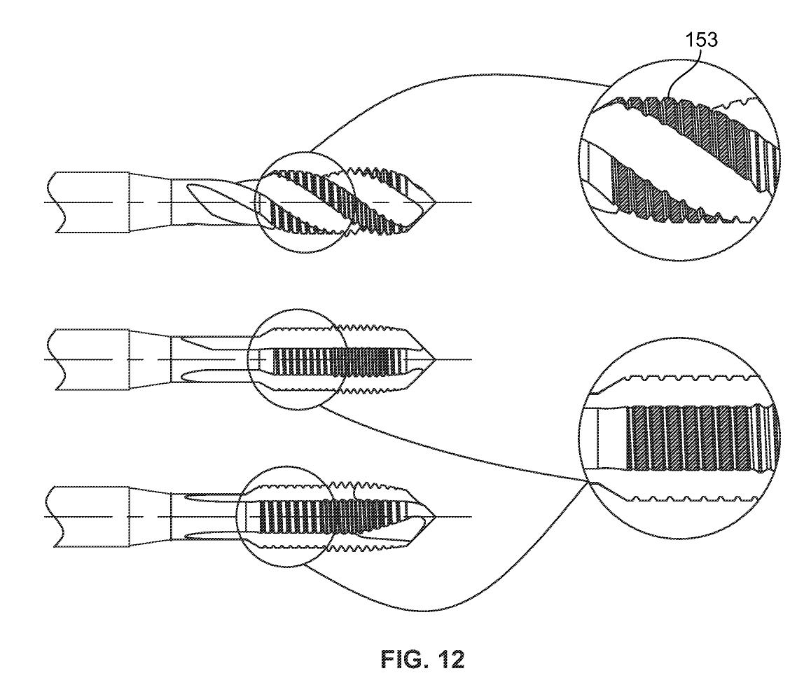

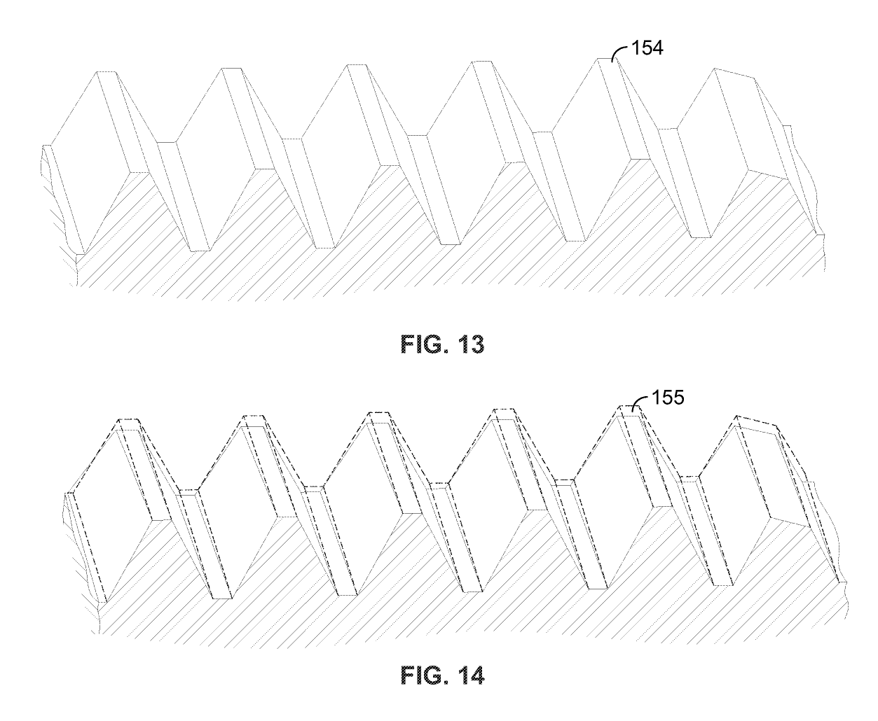

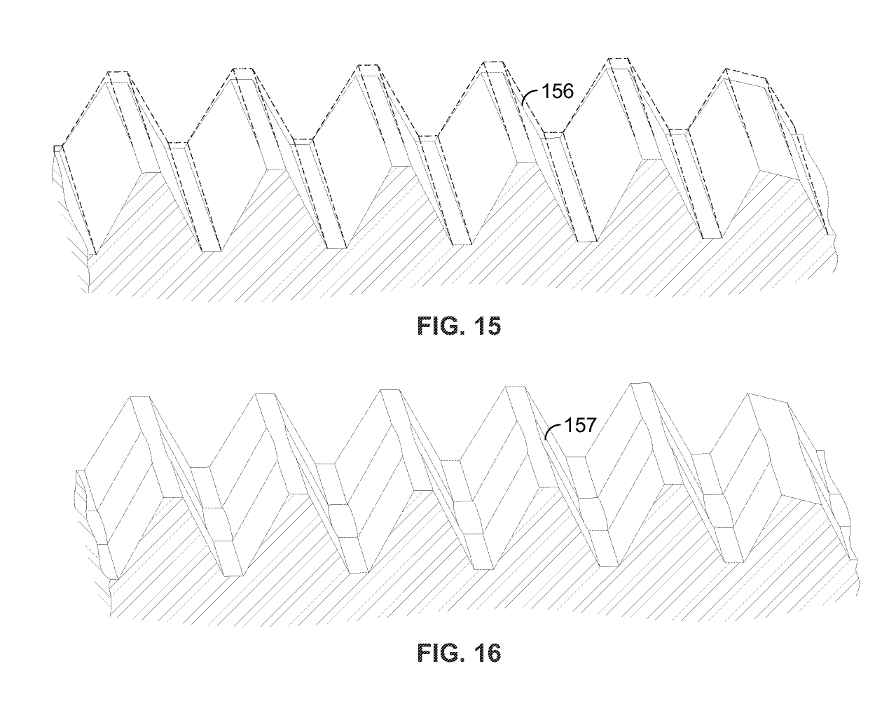

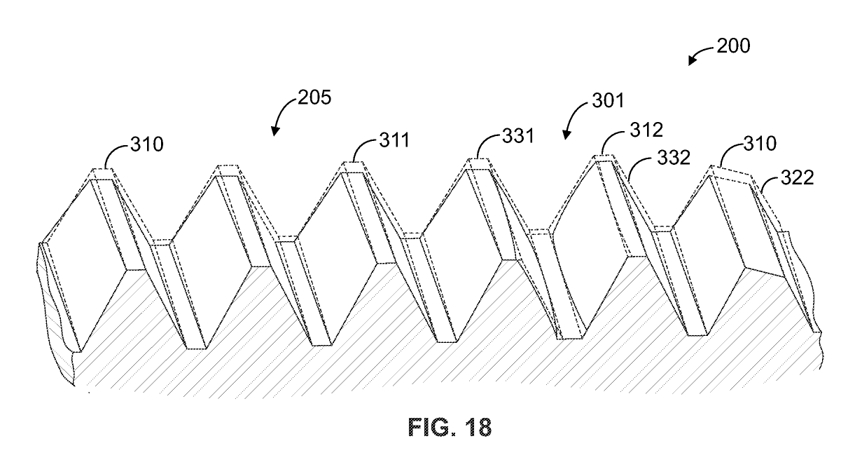

FIGS. 18-25 shows a dual relief tap 200 for cutting a thread into a workpiece. The tap 200 as numbered in FIGS. 2-4 includes a cylindrical tool body 201 having a longitudinal axis 202 rotatable about the longitudinal axis 202 and having successively along the cylindrical tool body a shank 203, a neck 204 (in some embodiments), a threaded length 205 with a plurality of threads (as shown in FIGS. 18-25) with at least a flute 206 for creating at least a land 207 with a front cutting face 208 with a cutting edge 209, and a chamfer area 210. These different parts of the tap 200 are shown in the general illustration of a tap in FIG. 2. A tap without a neck 204 is shown in FIG. 17A, while a tap with a neck 204 is shown in FIGS. 2-4. Further, the tap 200 shown in FIG. 17A does not include a chamfer 210, while the taps shown in FIGS. 2-4 include a chamfer 210. This disclosure is directed to all different tap configurations, with or without a chamfer, a neck, or other secondary features.

What is disclosed is a tap 200 where each of the plurality of threads has either similar or different geometries, such as, for example, the pitch as shown in FIGS. 18-24, but where each of the plurality of threads has a compound relief 310 made of least two different reliefs where one portion of the threads 311 has a first type of relief resulting either from a new type of relief or from a different geometry of tooth, and a second portion of the threads 312 has a second type of relief. In turn, the first and second portions 311, 312 can include only identical threads with identical reliefs, but the first portion 311 can include a first segment of the threaded length 321 with a first portion of the plurality of threads 311 where each of the plurality of threads in the first portion 311 has a first type of relief 331, and wherein a second segment 322 of the threaded length 205 includes a second portion 312 of the plurality of threads where each of the plurality of threads in the second portion 312 has a second type of relief 332.

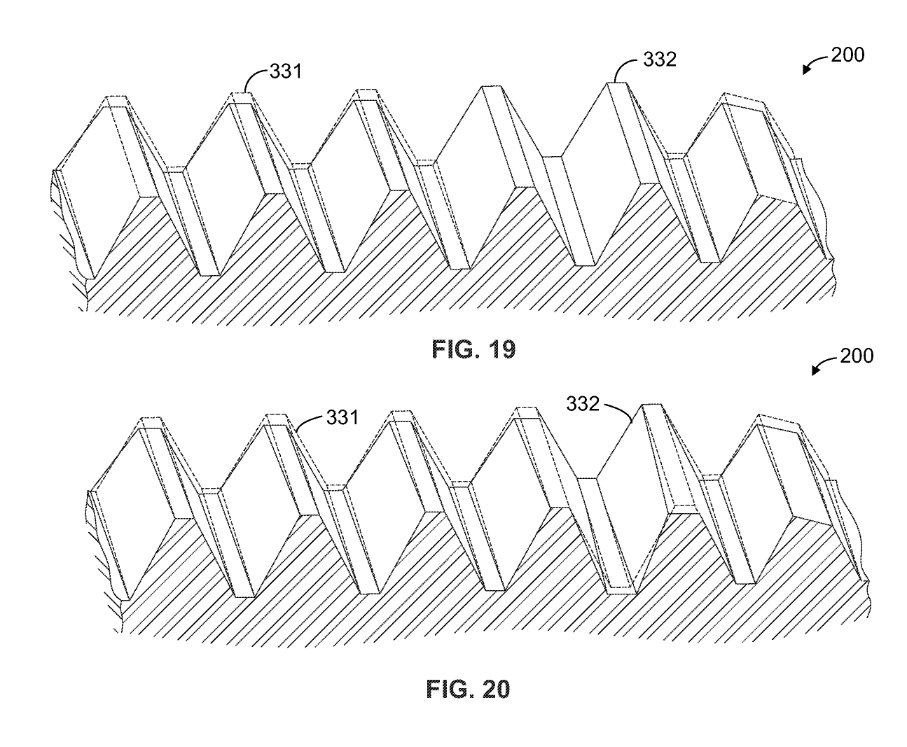

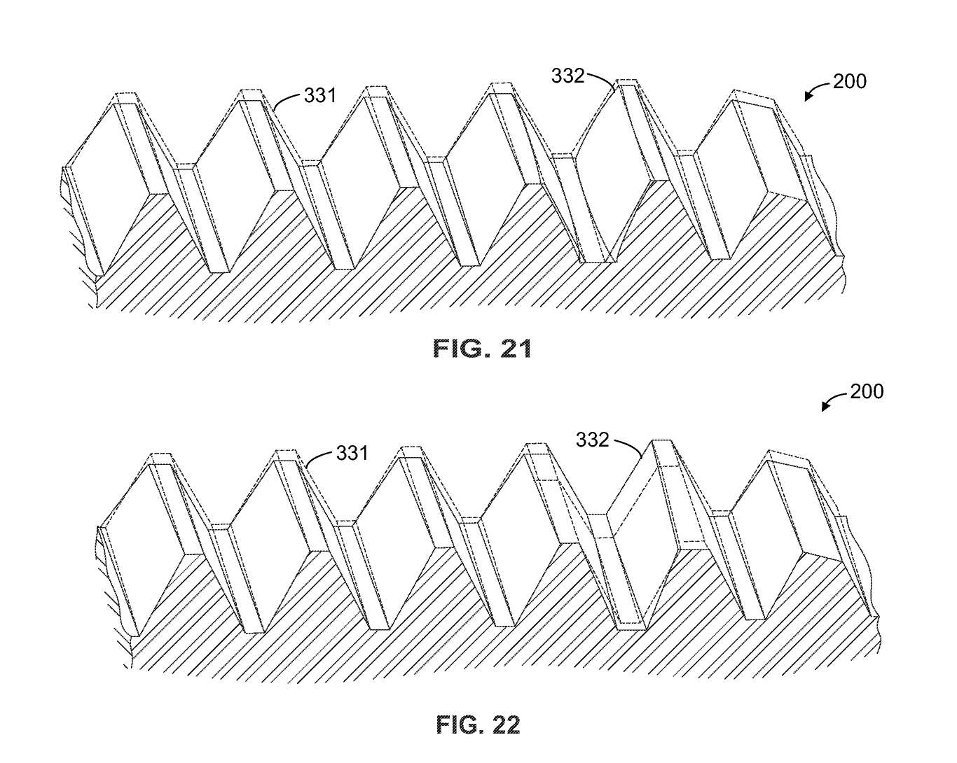

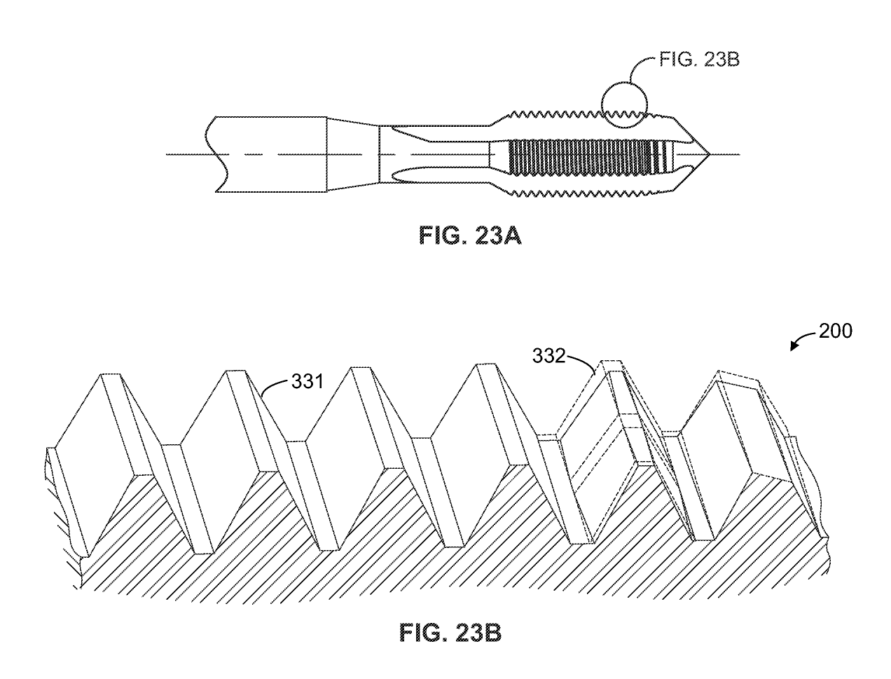

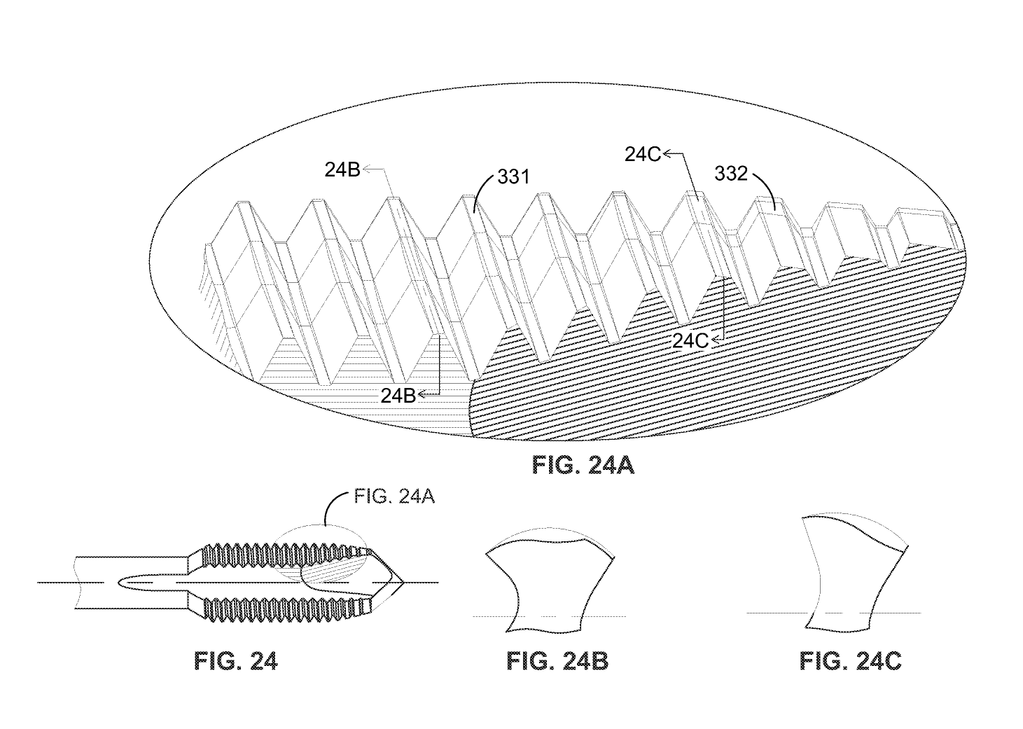

As illustrative examples of a tap 200 with different portions 311, 312, each with different threaded lengths 321, 322 and different types of relief 331, 332, FIG. 18 shows a tap 200 with an eccentric relief as a first type of relief 331 and a convex relief as a second type of relief 332. FIG. 19 shows a tap 200 with a first eccentric relief 331 and a second relief such as simple concentric threads 332. FIG. 20 shows a tap 200 a first eccentric relief 331 and a second negative relief 332. FIG. 21 shows a tap 200 with a first eccentric relief 331 and a second convex relief 332. FIG. 22 shows a tap 200 with first eccentric relief 331 and a second relief made of combined negative relief threads and concentric threads 332 according to another embodiment of the present disclosure. FIG. 23 is a dual relief technology tap with a first relief as concentric threads 331 and a second relief made of concentric threads and specially shaped relief 332. FIG. 23 shows a gunpoint tap 200, and FIG. 24 is a close-up view of the gunpoint tap 200 as shown in FIG. 23 with a dual relief technology with a first eccentric relief 331 and a second combined eccentric, negative, and positive relief, and concentric threads 332.

While FIGS. 18-22 and 24 illustrate some of the possible configurations of the first and second reliefs 331, 332 on the different portions of the threaded length 205 of the tap 200, taps 200 where the first relief 331 is a an eccentric relief, a flattened thread relief, a removed thread relief, a concentric thread, a con-eccentric relief, a special shape relief, a convex relief, a positive relief, a negative relief, or any combination thereof are contemplated. Also, the second relief 332 may also be any of the eccentric relief, the flattened thread relief, the removed thread relief, concentric threads, the con-eccentric relief, the special shape relief, the convex relief, the positive relief, the negative relief, or any variation thereof. One of ordinary skill in the art will recognize that while a list of known relief types is given, any type of relief is also contemplated.

In another embodiment, the first segment 331 and second segment 332 are of the length of the threaded length 205. In another embodiment, the first segment 331 is substantially longer than the second segment 332. For example, the second segment 332 as shown in most of FIGS. 18-22 and 24 is one or two threads in length. In one embodiment, the second segment 332 is one to five threads in length, in a further embodiment, the second segment 332 is made of one to three threads, and in yet another embodiment, the second segment 332 is made of two threads in length.

Further, the second segment 332 may be either in or adjacent to the chamfer area as part of several threads immediately between the first segment 331 and second segment 332. While configurations of threads are described where two different segments and thread reliefs are shown, the use of other segments, thread reliefs, and portions are contemplated, such as, for example, a third segment of the threaded length with a third portion of the plurality of threads, and wherein the threads from the third portion have a second type of relief, a third type of relief, etc. The principle of this disclosure centers around, at a minimum, the use of selected threads having different relief technologies to alter the side effects resulting from the use of threads with a first technology in a threaded area of a tap. These teachings are consistent with the use of more than one corrective thread; the use of two or more corrective threads along the threaded area is also contemplated. Further, the second portion 312 may be located between the first portion 311 and the third portion on the threaded length or any other area along the threaded length 205.

In another embodiment, a method for reducing the overfeed and/or underfeed of a dual relief tap 200 in a workpiece is also contemplated, the method comprising the steps of placing a shank of a dual relief tap 200 in a support 36 and turning the tap 200 into a workpiece along the longitudinal axis 202. In another embodiment, the method may include a further step of inserting a second segment 322 into the workpiece and inserting at least a portion of the first segment 321 into the workpiece.

It is understood that the preceding is merely a detailed description of some examples and embodiments of the present invention and that numerous alterations to the disclosed embodiments can be made in accordance with the disclosure herein without departing from the spirit or scope of the invention. The preceding description, therefore, is not meant to limit the scope of the invention but to provide sufficient disclosure to one of ordinary skill in the art to practice the invention without undue burden.

What is claimed is:

1. A dual relief tap for cutting a thread into a workpiece, comprising:
a cylindrical tool body having a longitudinal axis rotatable about the longitudinal axis and having successively along the cylindrical tool body a shank, a threaded length with a plurality of threads with at least a flute for creating at least a land with a front cutting face with a cutting edge, and a chamfer area,
wherein each of the plurality of threads has a similar geometry aside from a type of relief,
wherein a first segment of the threaded length includes a first portion of the plurality of threads where each of the plurality of threads in the first portion has a first type of relief, and
wherein a second segment of the threaded length includes a second portion of the plurality of threads where each of the plurality of threads in the second portion has a second type of relief.

2. The dual relief tap of claim 1, wherein the relief of the first type is selected from the group consisting of eccentric relief, flattened thread relief, removed thread relief, con-eccentric relief, specially shaped relief, convex relief, positive relief, and negative relief.

3. The dual relief tap of claim 1, wherein the relief of the second type is selected from the group consisting of eccentric relief, flattened thread relief, removed thread relief, con-eccentric relief, specially shaped relief, convex relief, positive relief, and negative relief.

4. The dual relief technology tap of claim 3, wherein one of the type of relief further includes a concentric thread.

5. The dual relief tap of claim 1, wherein the length of the first segment plus the length of the second segment are equal to the length of the threaded length.

6. The dual relief tap of claim 1, wherein the first segment is substantially longer than the second segment.

7. The dual relief tap of claim 1, wherein the second segment is made of one to five threads.

8. The dual relief tap of claim 1, wherein the second segment is made of one to three threads.

9. The dual relief tap of claim 1, wherein the second segment is made of two threads.

10. The dual relief tap of claim 1, wherein the second segment is adjacent the chamfer area.

11. The dual relief tap of claim 1, further comprising a third segment of the threaded length with a third portion of the plurality of threads, and wherein the threads from the third portion have the second type of relief.

12. The dual relief tap of claim 11, wherein the second portion is located between the first and third portions on the threaded length.

13. The dual relief tap of claim 1, wherein the second type of relief is a composite relief made of at least two different types of relief on different portions of at least a thread of the second portion.

14. The dual relief technology tap of claim 13, wherein the at least two different types of relief are selected from the group consisting of eccentric relief, flattened thread relief, removed thread relief, con-eccentric relief, specially shaped relief, convex relief, positive relief, and negative relief.

15. The dual relief technology tap of claim 14, wherein one of the types of relief further includes a concentric thread.

16. A method of reducing the overfeed and/or underfeed in a workpiece with a dual relief tap, the method comprising the steps of:
placing a shank of a dual relief tap in a support, the tap having a cylindrical tool body with a longitudinal axis rotatable about the longitudinal axis and having successively along the cylindrical tool body a threaded length with a plurality of threads with at least a flute for creating at least a land with a front cutting face with a cutting edge, wherein each of the plurality of threads has a similar geometry aside from a type of relief, wherein a first segment of the threaded length with a first portion of the plurality of threads where each of the plurality of threads in the first portion has a first type of relief, and wherein a second segment of the threaded length includes a second portion of the plurality of threads where each of the plurality of threads in the second portion has a second type of relief; and
turning the tap into a workpiece along the longitudinal axis.

17. The method of claim 16, wherein the relief of the first type is selected from the group consisting of eccentric relief, flattened thread relief, removed thread relief, con-eccentric relief, specially shaped relief, convex relief, positive relief, and negative relief.

18. The method of claim 17, wherein the relief of the second type is selected from the group consisting of eccentric relief, flattened thread relief, removed thread relief, con-eccentric relief, specially shaped relief, convex relief, positive relief, and negative relief.

19. The method of claim 16, further comprising the steps in order of inserting the second segment into the workpiece and inserting at least a portion of the first segment into the workpiece.

20. The method of claim 18, wherein one of the types of relief further includes a concentric thread.
